(19) United States
(12) Patent Application Publication
(10) Pub. No.: US 2004/0083238 A1
(43) Pub. Date: Apr. 29, 2004

(54) Method, system, and storage medium for integrating project management tools

(75) Inventors: Tom St. Louis, Schenectady, NY (US); Michael Robert LaBlanc, Wilton, NY (US); Mark Mitchell Kornfein, Latham, NY (US)

Correspondence Address: General Electric Company, CRD Patent Docket Rm 4A59, Bldg. K-1, P.O. Box 8, Schenectady, NY, 12301, US

(73) Assignee: General Electric Company

(21) Appl. No.: 10/278,548

(22) Filed: Oct. 24, 2002

(51) Int. Cl. G06F 12/00

(52) U.S. Cl. 707/200

(57) ABSTRACT

An exemplary embodiment of the invention relates to a method, system, and storage medium for integrating project management tools. The method includes obtaining a first instance from a first project management application; obtaining a second instance from a second project management application; translating data fields and values from the first project management application and the second project management application into a common format; comparing the values of the data fields against a most recent synchronized data and data fields; and performing a synchronization action in response thereto. Synchronization actions include adding a project task, updating a project task, deleting a project task, and resolving conflicts among data values. The synchronization action can be initiated automatically in response to predetermined events or in response to a user request. The invention also includes a system and a storage medium.

### BACKGROUND OF THE INVENTION

The present invention relates to project management systems, and more particularly, to a method, system, and storage medium for integrating project management applications.

Project management generally refers to the application of knowledge, skills, tools, and techniques for implementing a project plan. Project leaders are typically assigned to direct a project team through the various phases of implementation resulting in one or more project deliverables or end products. Many businesses today utilize project management software for planning, executing, and reporting projects. There are, in fact, various commercial off-the-shelf project management applications on the market ranging from industry-specific tools to more generalized, broad-based applications.

For example, Microsoft Project 2000™ allows a project planner to create a working schedule from information provided relating to tasks, resources, and costs. It features project outlines or levels of hierarchy that enable users to create customized project structures and substructures. It also includes a tracking component for calendaring start dates, review dates, and deadlines. Project milestones can be set and reviewed periodically utilizing the tool's management features. Resource allocation and critical path analysis features are also available with this tool. One notable disadvantage of this software is that it does not provide for web-based collaborative project planning and implementation.

Other project tools on the market offer varying features and services such as web-based capabilities and reporting functions. As business needs change and software and hardware technology evolve, newer and more advanced programs are developed. For many businesses that have invested significant time and resources planning and developing their hardware and software infrastructures, the prospect of upgrading these systems to integrate them with new or enhanced systems and applications can be a daunting and unwelcome challenge. Trusted software tools that are convenient and familiar to business employees hold value even when certain features are lacking or have become less beneficial over time.

Disparate systems and software tools result in project leaders being forced to either choose between project management applications or, alternatively, enter duplicate data and manually synchronize the information in order to achieve the benefits offered by these multiple software tools.

What is needed is a way to integrate project management software tools such that users can take advantage of their individual features without performing duplicate manual entry.

### BRIEF SUMMARY OF THE INVENTION

An exemplary embodiment of the invention relates to a method, system, and storage medium for integrating project management tools. The method includes obtaining a first instance from a first project management application; obtaining a second instance from a second project management application; translating data fields and values from the first project management application and the second project management application into a common format; comparing the values of the data fields against a most recent synchronized data and data fields; and performing a synchronization action in response thereto. Synchronization actions include adding a project task, updating a project task, deleting a project task, and resolving conflicts among data values. The synchronization action can be initiated automatically in response to predetermined events or in response to a user request. The invention also includes a system and a storage medium.

### BRIEF DESCRIPTION OF THE DRAWINGS

The above described features and functions of embodiments of the invention will now be described with reference to the following figures.

FIG. 1 is a block diagram of the system components utilized by the integration system in an exemplary embodiment of the invention;

FIG. 2 is a flowchart illustrating the process of integrating project management applications in an exemplary embodiment of the invention;

FIG. 3 is a diagram illustrating an ‘add project task’ scenario synchronized by the integration system in an exemplary embodiment;

FIG. 4 is a diagram illustrating an ‘update project task’ scenario synchronized by the integration system in an exemplary embodiment;

FIG. 5 is a diagram illustrating a ‘delete project activity’ scenario synchronized by the integration system in an exemplary embodiment;

FIG. 6 is a diagram illustrating an ‘update project task’ scenario and confirmation dialog box for a noted conflict that is created and synchronized by the integration system in an exemplary embodiment; and

FIG. 7 is a diagram illustrating a ‘delete project’ scenario and confirmation dialog box created and synchronized by the integration system in an exemplary embodiment.

### DETAILED DESCRIPTION OF THE INVENTION

In one embodiment, the integration system includes an automated software process that provides integration and synchronization between two disparate project management software applications. Common task level data elements from both applications are mapped and synchronized. The process includes a mechanism for linking and comparing the task level entries and for providing ongoing bi-directional synchronization. Conflicting data elements (also referred to as concurrent update collisions) are interactively acted upon by a project leader or other designated individual. The actual synchronization process may be initiated by pre-determined events and/or direct end-user requests.

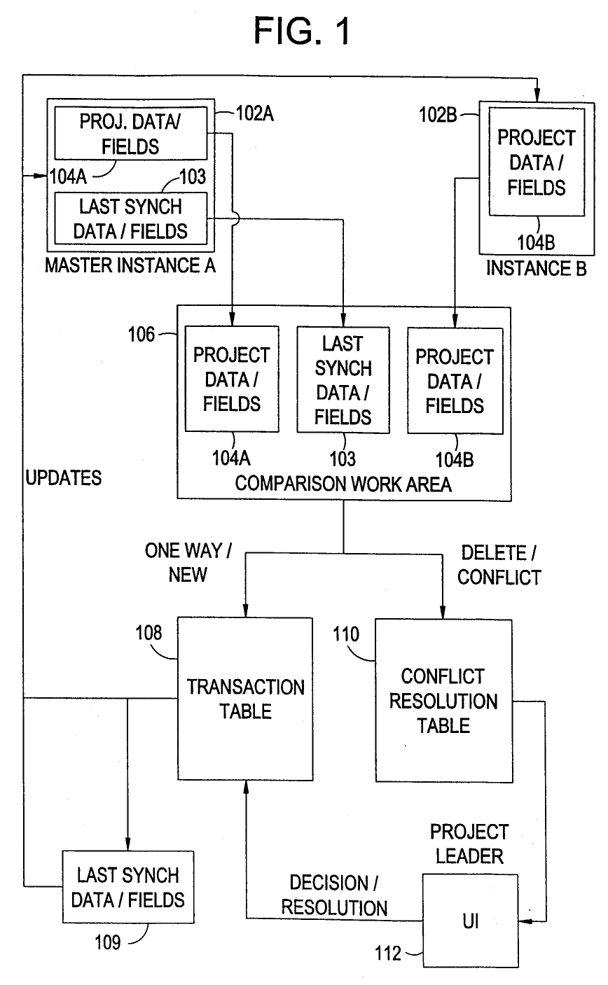

The components of the integration system will now be described with reference to FIG. 1. A master project instance 102A (also referred to herein as “instance A”) contains information pertaining to an existing project created by a project planner. Instance ‘A’ 102A is created utilizing a project management software application and is stored in computer memory. Also included in the system is a second project instance 102B (also referred to as “instance B”), which may be created by a project planner utilizing a second project management software application different from the first. Instance A (102A) and instance B (102B) both correspond to the same project but were created utilizing different project management software applications. Alternatively, a project instance may be initially created utilizing the second project management software in which case instance B (102B) would be referred to as the master project instance.

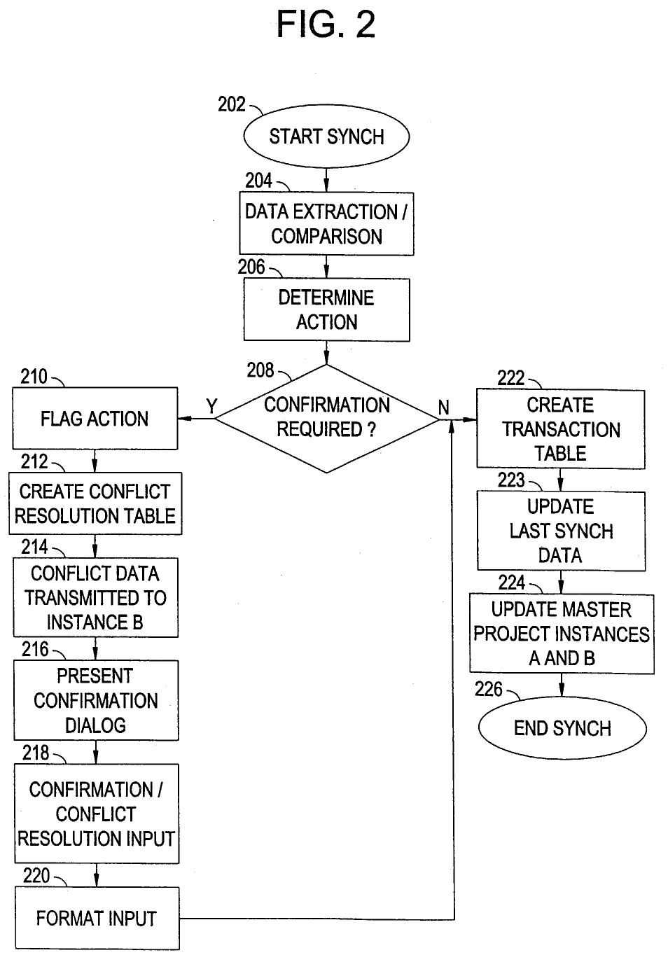

Data fields comprising a project management application are determined and defined by the creators of the software and may vary from application to application as will be seen in the following figures and description. Selected data fields or groups of data fields 104A and 104B and their corresponding values, if any, are stored in master project instance 102A and instance 102B, respectively. The data extracted include identifying information for the project and relevant task information. Master project instance 102A also comprises synchronized data and data fields 103 and is described further in FIG. 2. The system also comprises a temporary storage area (also referred to as a comparison work area) 106, which may be located in a computer system's random access memory (RAM). Comparison work area 106 receives the data fields 104A, 104B and their corresponding values, as well as the synchronized data and data fields 103 for analysis and comparison as described further in FIG. 2. The system also comprises a transaction table 108 and a conflict resolution table 110 that are created by the integration system as needed depending upon the results of the analyses performed in comparison work area 106. Last synchronized data/fields 109 stores newly synchronized and updated project data information resulting from activities performed as described in FIG. 2. The system further comprises central processing units 112, a supporting communications medium, and a user interface for presenting confirmation requests to project leaders or designated personnel for action.

A project leader can utilize one or more project management tools independently of the integration system or in conjunction with the integration system as described further herein. A user, such as a project leader, typically creates a new project utilizing an existing project management tool and saves the project with or without specific task level data or other similar inputs. The user can later modify the project data as required via the project management tool. Should the user decide to integrate the project data with a second project application, however, he/she may do so by initiating the integration system. In this manner, the user can take advantage of the benefits offered by both project applications as applied to the single project.

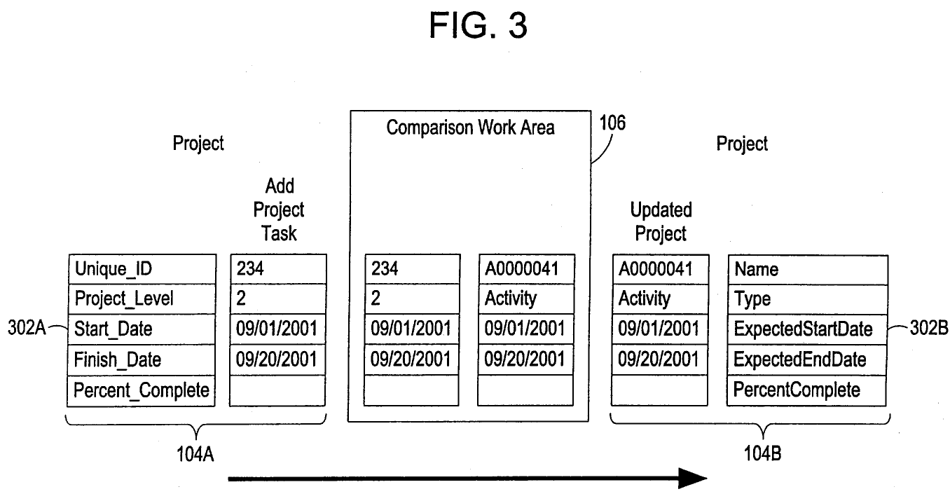

The flowchart of FIG. 2 assumes that a project has been created and saved in two separate project management instances such as instances 102A and 102B utilizing two different project management software applications (referred to herein as a first project management tool and a second project management application). A user initiates the integration system, or alternatively, the synchronization process of the integration system is automatically initiated at step 202. The integration system may be initiated where a user is creating, modifying, or deleting a project, a project task, date, or other similar information. The integration system extracts data fields 104A, 104B and their corresponding values, as well as the synchronized data and data fields 103 from the project management applications, places them in comparison work area 106, and translates the data fields 104A and 104B into a common format at step 204. The comparison work area 106 allows the integration system to evaluate and compare data relating to a project that is received from two project management applications. Translation of the data can be achieved by matching individual data fields from one project management application to corresponding data fields of a third set 103 (also referred to as synchronized data and data fields), in a common format, which represents the most recent synchronized state for each data element in master instance A (102A). Data translation and comparison is performed with the extracted data from both project management applications. Each set of data is compared against the last synchronized state data so that both sets of data are compared against the same base. In this manner, inserts, deletes, and conflicts resulting from activity in a particular project management application are accurately detected. For example, data field 302A “Start_Date” of FIG. 3 has been mapped to corresponding data field 302B “ExpectedStartDate”, indicating that the two data fields relate to the same information. Comparison functions may be performed with the assistance of an algorithm. For example, an instruction is issued that checks the values of data fields 302A and 302B and returns a ‘positive’ response if the two values are equal (e.g., matching).

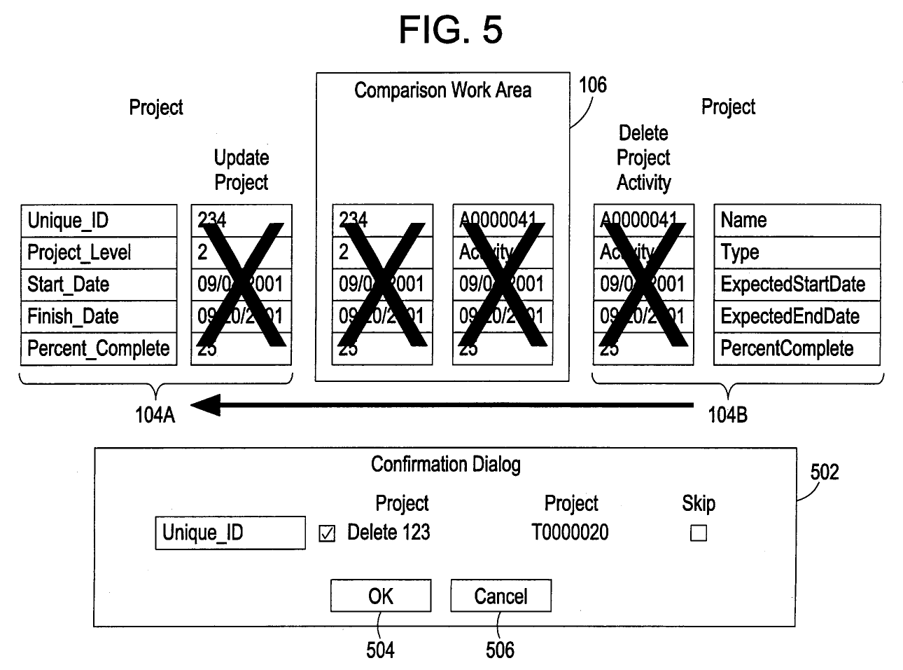

The integration system then determines what action is required to be taken, if any, at step 206. This step includes evaluating the type of action being requested by a user (e.g., add new, modify, delete data, etc.), the project task level involved, which project application must be updated (e.g., which way the information flow/update will occur), and whether a confirmation is necessary before executing the action. Levels of hierarchy or project levels have associated identifiers to indicate specific tasks where multiple project levels have been created for a given project. Project tasks include units of work that are organized in meaningful increments, collectively resulting in a project outline or structure. Actions that may require confirmation include a request to delete information in either project application and/or requested modifications that result in conflicting project information. Any actions requiring confirmation at step 208 are flagged by the integration system at step 210. If a confirmation is required, a conflict resolution table 110 is created by the integration system at step 212. Conflict resolution table 110 contains the data fields and values for project tasks in which a conflict has been noted or in which a request to delete information is received. The conflict data is transmitted to instance B (102B) at step 214. In one embodiment, this transmission is performed via a web-based real-time application. A confirmation dialog is presented to a designated individual at CPU 112 for confirmation input in response to deletes and conflicts in order to resolve the conflict or confirm the deletion request at step 216. The confirmation dialog box is acted upon by the designated individual at step 218. Confirmation dialog boxes are shown generally in FIGS. 5-7. The resolution information is then formatted at step 220, transmitted to transaction table 108 at step 222 which is created by the integration system, followed by updating the newly-synchronized data in ‘last synchronized data/fields 109 at step 223. The appropriate instances 102A and 102B are then updated at step 224.

If a confirmation is not required at step 208, the action specified by the user is processed and updated as described in steps 222 to 224. The last synchronized state is recorded and stored in a web-based data repository and the synchronization process ends at step 226.

FIGS. 3-7 illustrate the various scenarios encountered by the integration system as a result of a user initiating the synchronization process. Selected data fields 104A and 104B and their values extracted from the two project applications are placed into comparison work area 106 located in temporary storage. Relevant data fields may include a name or identifier for the project and/or project task, a project level or type indicator, start and end dates, and percentage complete values. Other information can be selected in lieu of or in addition to the above fields if desired. A comparison algorithm is performed on the data in order to match data fields and data between the project applications. The modified data is then updated in the corresponding project management application file. It will be understood that this information can be transferred both ways resulting in bi-directional update capabilities.

FIG. 3 illustrates an ‘add project task’ scenario as synchronized by the integration system. A project task identified as “234” has been assigned via the first project management application. The values provided by the user in the data fields are copied to the comparison work area, translated to a common format, and updated in the second project management application. Thus, the directional flow of information is from the first project management application to the second project management application and is referred to as a one-way action. It will be noted that no confirmation for this type of action is needed.

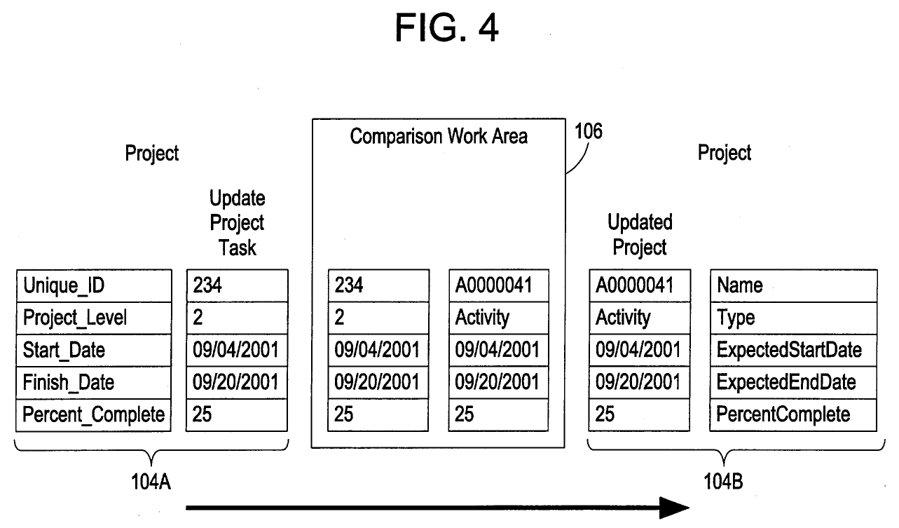

FIG. 4 illustrates an ‘update project task’ scenario as synchronized by the integration system. The data to be updated is the ‘start date’ field value and ‘percent complete’ field value. The information is provided to the first project management application and is updated to the second project management application.

FIG. 5 illustrates a ‘delete activity’ scenario as synchronized by the integration system. The relevant activity data to be deleted is identified and executed in the second project application and the integration system updates the corresponding project data in the first project management application. A ‘delete’ action triggers a confirmatory flag by the integration system that results in an entry in the conflict resolution table 110 that is presented to a specified individual for review and approval. Confirmation dialog box 502 comprises the relevant data associated with the deletion request from both project management applications with a corresponding ‘checkbox’ next to the item to be deleted. The individual can select ‘OK’ 504 which will cause the ‘delete’ action to be executed in the first project management application, or the individual can select ‘Cancel’ 506 which preempts execution of the action.

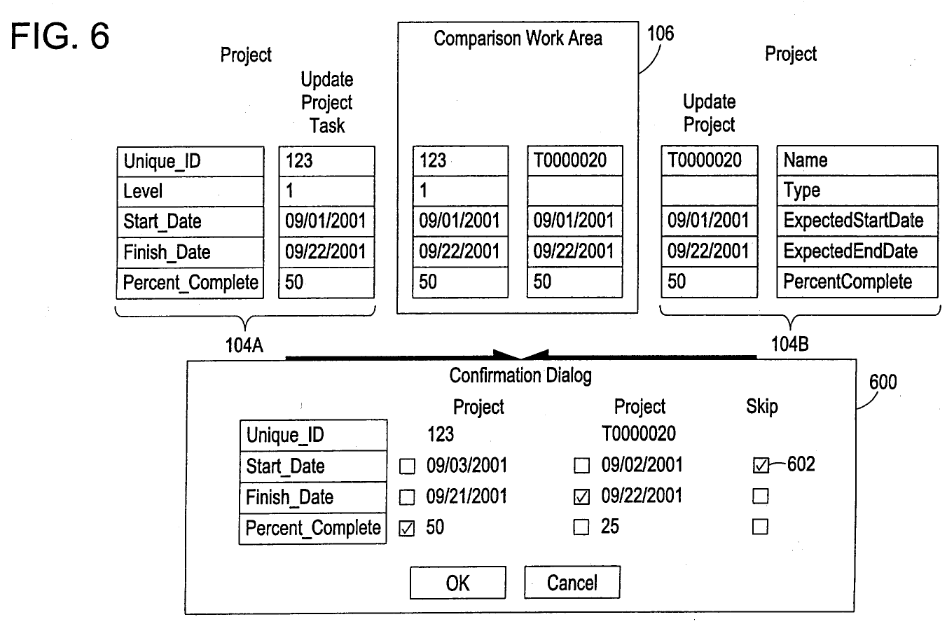

FIG. 6 illustrates an ‘update project task’ scenario as synchronized by the integration system upon a conflict caused by contradicting information provided for one or more data fields at both project management applications. The data in conflict as shown in FIG. 6 include the start date, finish date, and the percent complete value. When the integration system detects a conflict, it creates entries in conflict resolution table 110 that are presented to the user in the confirmation dialog box 600 with an option for selecting a preferred value from the conflicting items. In the confirmation dialog box of FIG. 6, a user has selected “9/22/2001” over the conflicting finish date of “9/21/2001”. The user has also selected a percentage complete value of “50” over the conflicting value of “25”. The conflicting values of the start date were left unaltered by the user as evidenced by selecting the “Skip” box 602.

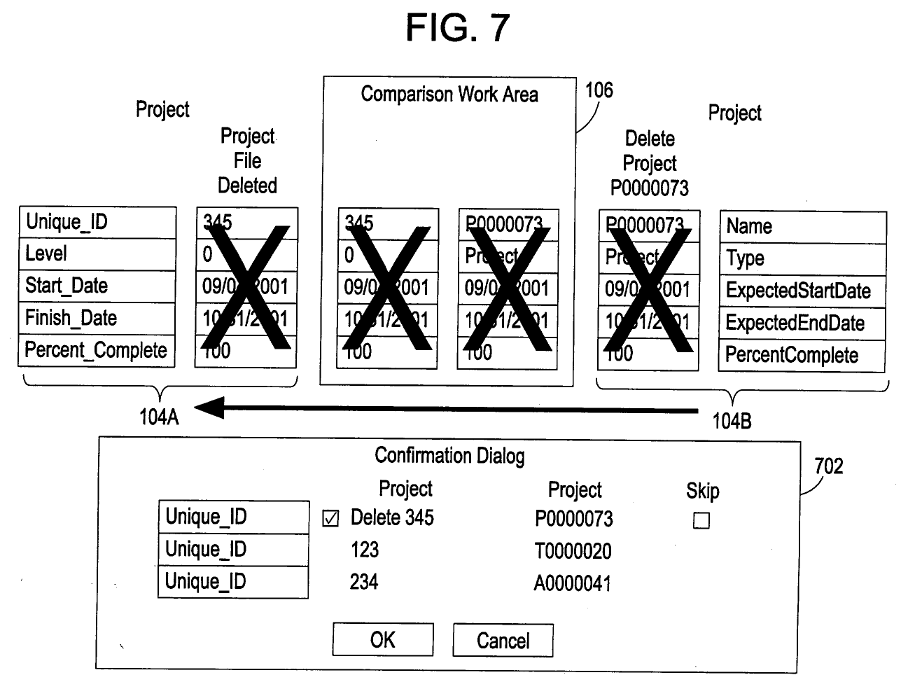

FIG. 7 illustrates a ‘delete project’ scenario as synchronized by the integration system. In this example, an entire project and all of its corresponding tasks and data are being deleted from the first project management application. A confirmation dialog box 702 is generated by the integration system and transmitted to a specified individual for review. Once confirmed, the entire project is deleted from the first project management application.

As described above, the integration system provides integration and synchronization between two disparate project management software applications. Common task level data elements from these applications are mapped and synchronized. The process enables bi-directional synchronization. Conflicting data elements are interactively acted upon by a project leader or other designated individual. It will be understood that while the features and functions of the integration system have been described with respect to project management applications, minor variations and extensions of the integration system may be developed for use in other software applications. As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation. Moreover, the use of the terms first, second, etc. do not denote any order or importance, but rather the terms first, second, etc. are used to distinguish one element from another.

1. A method for integrating project management tools, comprising:
obtaining a first instance from a first project management application;
obtaining a second instance from a second project management application;
translating data fields and values from said first project management application and said second project management application into a common format;
comparing said values of said data fields against a most recent synchronized data and data fields; and
performing a synchronization action in response to said comparing.

2. The method of claim 1, wherein said synchronization action is initiated automatically in response to predetermined events.

3. The method of claim 1, wherein said synchronization action is initiated in response to a user request.

4. The method of claim 1, wherein said performing a synchronization action includes:
evaluating a type of action being requested;
determining a project task level for said type of action;
determining which project management application to update; and
determining whether a confirmation is required before executing said synchronization action.

5. The method of claim 1, wherein said type of action includes adding a project task to said first instance and said second instance.

6. The method of claim 1, wherein said synchronization action includes updating a project task in said first instance and said second instance.

7. The method of claim 1, wherein said synchronization action includes deleting a project task from said first instance and said second instance.

8. The method of claim 1, wherein said type of action includes resolving conflicts in data field values detected in said first instance and said second instance, said conflicts detected via a comparison work area.

9. The method of claim 8, wherein said resolving conflicts in said data field values includes:
generating a confirmation dialog box, said confirmation dialog box including conflict data and check boxes operable for selecting a preferred data value;
presenting said confirmation dialog box to a designated individual over a communications network; and
upon receiving a response from said designated individual, updating said first instance and said second instance according to said response.

10. The method of claim 1, wherein said synchronization action occurs bi-directionally between said first project management application and said second project management application.

11. The method of claim 1, wherein said translating data fields from said first project management application and said second project management application into a common format includes:
extracting data fields and corresponding values from said first project management application and said second project management application; and
placing said data fields and corresponding values into a comparison work area.

12. The method of claim 1, wherein said translating data fields from said first project management application and said second project management application into a common format includes:
matching individual data fields from said first project management application to corresponding data fields of said most recent synchronized data and data fields; and
matching individual data fields from said second project management application to corresponding data fields of said most recent synchronized data and data fields.

13. The method of claim 1, wherein said comparing values of said data fields is performed via an algorithm.

14. A storage medium encoded with machine-readable computer program code for integrating project management tools, the storage medium including instructions for causing a computer to implement a method, comprising:
obtaining a first instance from a first project management application;
obtaining a second instance from a second project management application;
translating data fields and values from said first project management application and said second project management application into a common format;
comparing said values of said data fields against a most recent synchronized data and data fields; and
performing a synchronization action in response to said comparing.

15. The storage medium of claim 14, wherein said synchronization action is initiated automatically in response to predetermined events.

16. The storage medium of claim 14, wherein said synchronization action is initiated in response to a user request.

17. The storage medium of claim 14, wherein said performing a synchronization action includes:
evaluating a type of action being requested;
determining a project task level for said type of action;
determining which project management application to update; and determining whether a confirmation is required before executing said synchronization action.

18. The storage medium of claim 14, wherein said type of action includes adding a project task to said first instance and said second instance.

19. The storage medium of claim 14, wherein said synchronization action includes updating a project task in said first instance and said second instance.

20. The storage medium of claim 14, wherein said synchronization action includes deleting a project task from said first instance and said second instance.

21. The storage medium of claim 14, wherein said type of action includes resolving conflicts in data field values detected in said first instance and said second instance, said conflicts detected via a comparison work area.

22. The storage medium of claim 21, wherein said resolving conflicts in said data field values includes:
generating a confirmation dialog box, said confirmation dialog box including conflict data and check boxes operable for selecting a preferred data value;
presenting said confirmation dialog box to a designated individual over a communications network; and
upon receiving a response from said designated individual, updating said first instance and said second instance according to said response.

23. The storage medium of claim 14, wherein said synchronization action occurs bi-directionally between said first project management application and said second project management application.

24. The storage medium of claim 14, wherein said translating data fields from said first project management application and said second project management application into a common format includes:
extracting data fields and corresponding values from said first project management application and said second project management application; and
placing said data fields and corresponding values into a comparison work area.

25. The storage medium of claim 14, wherein said translating data fields from said first project management application and said second project management application into a common format includes:
matching individual data fields from said first project management application to corresponding data fields of said most recent synchronized data and data fields; and
matching individual data fields from said second project management application to corresponding data fields of said most recent synchronized data.

26. The storage medium of claim 14, wherein said comparing values of said data fields is performed via an algorithm.

27. A web-based integration system for integrating project management tools, said integration system in communication with a first project management application, a second project management application, and a plurality of central processing units including memory, a communications medium, and a user interface, the integration system comprising:
a first instance associated with said first project management application;
a second instance associated with said second project management application;
a comparison work area operable for receiving data fields and corresponding values from said first instance and said second instance and a most recent synchronized data and data fields;
a transaction table; and
a conflict resolution table.

28. The web-based integration system of claim 27, wherein said corresponding values of said data fields are synchronized in said first instance and said second instance via said transaction table.

29. The web-based integration system of claim 27, wherein said corresponding values of said data fields are synchronized in said first instance and said second instance via said conflict resolution table.

30. The web-based integration system of claim 29, further comprising a confirmation dialog box, wherein upon detecting conflicting values between corresponding data fields, said data fields and conflicting values are transmitted to a project leader via said confirmation dialog box for resolution.

31. The web-based integration system of claim 30, wherein said confirmation dialog box contains data values for corresponding data fields from said first instance and said second instance and a request to delete at least one value from said data fields.

32. The web-based integration system of claim 28, wherein synchronization is performed in near real time.

33. The web-based integration system of claim 28, wherein said synchronization is performed bi-directionally between said first project management application and said second project management application.
